(19) United States
(12) Patent Application Publication
(10) Pub. No.: US 2002/0078444 A1
(43) Pub. Date: Jun. 20, 2002

(54) System and method for the scaleable delivery of targeted commercials

(76) Inventors: William Krewin, Pittsburgh, PA (US); Mordechai Gal-Or, Pittsburgh, PA (US)

Correspondence Address: Cohen & Grigsby, P.C., 15th Floor, 11 Stanwix Street, Pittsburgh, PA, 15222, US

(21) Appl. No.: 09/738,366

(22) Filed: Dec. 15, 2000

(51) Int. Cl. H04N 7/025; H04N 7/16; H04N 7/10

(52) U.S. Cl. 725/35; 725/32; 725/34

(57) ABSTRACT

A system for the delivery of targeted advertising wherein a viewer profiling system (10) distributes view profile data to control devices (20) or (22). Insertion orders (18) are broadcast to the control devices (20) or (22) and the control devices store selected insertion orders based on the profile data. Broadcast commercials are displayed according to the acquisition field of the stored insertion orders.

### BACKGROUND OF THE INVENTION

1. Field of the Invention

This invention relates to the broadcast distribution of commercial messages and, more particularly, the scaleable broadcast delivery of video advertising messages to selected viewer profiles that are defined according to given geographic, demographic, psychographic, group affiliation or other parameters.

2. Description of the Prior Art

For many years, video programs have been broadcast to large audiences. Along with the programs, the broadcasters delivered commercials. In the past, these commercials have generally been “broadcast commercials,” that is, commercials that are broadcast to all program viewers at a specific time on a specific channel during a scheduled program. It has been found that given programs attract audiences that can be characterized by certain demographic or other profiles. To efficiently deliver advertising messages, advertisers have purchased broadcast commercials in accordance with the viewer profile that is associated with a particular program.

In the 1980s, the advent of cable television introduced new competitive dynamics for traditional broadcast networks. Video programs are now delivered over analog and digital networks. Now, most digital cable and satellite systems support 300 to 700 video channels that offer viewers 3,000 to 10,000 hours of daily programming. This degree of program selection has fragmented the large viewing audiences that the network operators previously enjoyed. As a result of this audience fragmentation, advertisers find it increasingly expensive to reach viewers through the rapidly expanding universe of available programming.

Broadcast advertising has also been somewhat inefficient for the reason that ad views fail to reach the targeted viewer. As used herein, an “ad view” is the presentation of an advertisement to a viewer. A “targeted viewer” is a program viewer who meets a viewer profile or viewer criteria that are specified by the advertiser. To the extent that advertisements are presented to viewers who do not match a specified viewer profile, the ad views are considered to be wasted. For example, an automobile manufacturer may purchase advertising time in a national sports program with the intention that its advertisement will be presented to males who are within a given age range. In that example, the program audience is expected to be predominantly male, with a small percentage of females. To the extent that the audience is female, the “ad views” are wasted in the sense that the ad message is targeted at the larger male audience and is less likely to impact females' behavior. As the advertiser's target audience becomes more highly defined according to various parameters such as age, income and geographic location, the problem of the fragmentation of ad views becomes increasingly more significant.

To overcome this problem, advertisers would prefer to send “targeted commercials”—that is, commercials that are delivered to viewers who meet a viewer profile that is defined by specific demographic, psychographic, geographic, or affinity group characteristics. Thus, “targeted” viewers see a commercial that is specialized to their interests. Targeted commercials are more focused than broadcast commercials because targeted commercials discriminate the segment of the program audience that more specifically meets the advertisers' viewer profile. Thus, the program may attract an audience of a given spectrum of geography, channels, time and programming, but the targeted ad is only delivered to a smaller, more defined audience within that spectrum. In this way, targeted commercials are commercials that are more specifically presented to viewers that an advertiser wants to reach.

Two technologies have appeared that can help advertisers and network operators achieve the goal of targeted advertising. First, operators have been deploying addressable set-top boxes throughout satellite and digital cable networks that are rapidly merging with digital computer networks. This merger of computer and television networks has provided fundamental hardware to support customization of advertising on a personal level. Secondly, improvements to digital video recording technologies have enabled viewers to “time shift” a program; that is, to play a broadcast program at a time that suits their personal convenience. This “time shifting” aspect of digital video recording enables advertisers to reach an audience that can be defined independently of a viewer time dimension.

In the prior art, various systems have attempted to exploit one or even both of these technologies. For example, addressable converter systems, such as illustrated in U.S. Pat. Nos. 4,475,123, 4,625,235, 4,638,359, 4,716,410, assign a unique value to each device. Systems of this type deliver pay-per-view programming in response to a viewer order for a pay channel or pay-per-view event. In response to a viewer request, the broadcaster sends an authorization code to the addressable device to enable the viewing of the broadcast. On a national scale, this approach is not practical for the delivery of advertising because it would require sending an enabling code to each viewer device for each targeted ad that is to be viewed. This would require the daily transmission of several billion codes over a 300-channel digital cable. Such a level of data transmission would require several thousand channels, one for each targeted commercial at any point in time.

In an alternative approach, the data transmission load can be significantly reduced by storing each viewer selection criteria (geographic, demographic, psychographic) at the head-end of the cable distribution network and transmitting viewer profile data to the set-top box to cause the box to select the targeted advertisement. An example of this type of system is shown and described in U.S. Pat. No. 5,446,919 to Wilkins. This system requires sending a viewer profile to each decoder in a subscriber household. The decoder monitors a channel for a “selection profile” that is broadcast over a television network. When the decoder detects a selection profile that matches the “viewer profile” previously stored in the device, the decoder stores that selection profile. Thereafter, the decoder selects the alternate channel that displays the targeted advertisement.

The Wilkins system has several limitations. In Wilkins, the head-end stores demographic and psychographic information according to a given demographic/psychographic model. This means that a given advertisement message can be targeted only according to one encoding standard. However, there is no uniform standard for encoding such messages. Therefore, the viewer profile for a viewer serviced at one head-end might be encoded differently from a “viewer profile” for the same viewer at a second head-end. This greatly increases the number of advertisements that must be transmitted for a given viewer profile. Also, the Wilkins system requires the operator to implement expensive caching -and control server technologies to manage the delivery of targeted advertising. Finally, the specialized Wilkins system is not compatible with existing industry methods for the delivery of advertising and is not compatible with the current technology for personal video recorders.

U.S. Pat. No. 5,774,170 to Hite describes a two-step system that overcomes some of the foregoing limitations by eliminating the head-end as the arbiter of targeting. In the Hite system, the broadcaster embeds targeting information in the commercial. Specifically, Hite sends a commercial identifier called a “CID” to each subscriber's control device in advance of the actual commercial broadcast. Hite's control device (analogous to the decoder device in Wilkins) is responsive to a CID in the commercial to compare the CID that was previously stored in the control device. If the two CIDs match, the control device communicates with the central storage and thereby selects the commercial. In Hite's alternate embodiments, the control device detects the CID embedded in a recorded commercial (VCR, Personal Video Recorder, Video On Demand Head-end Recording) during the replay operation.

In contrast to Wilkins system, Hite's system gives advertisers control over the distribution of the advertisement. However, the Hite system requires advertisers to embed a different CID in each version of the advertisement for each viewer profile. If advertisers want to reach multiple viewer profiles, they must embed a different CID for each viewer profile of each commercial. The result is that the broadcaster must transmit the same commercial multiple times. This approach requires the network to transmit redundant instances of the commercial.

Moreover, the Hite system is also burdensome in that it requires that a CID for every commercial must be downloaded to every control device. For example, this might require the delivery of several billion CIDs each day. This download operation is inefficient and, given capacity limitations, may be impractical for larger networks, such as networks with a million or more viewers. Furthermore, Hite relies on the control device to communicate with the central storage device and to select an advertisement from the central storage device. Not all control devices have this capability for back-channel communication. Even with control devices having such capability, a large number of these individual “selections” in a large head-end might consume all available back-channel resources as well as the resources of the central storage device.

### SUMMARY OF THE INVENTION

In accordance with the presently disclosed invention, targeted advertisements are broadcast and displayed according to a pre-selected viewer profile. A control device receives and stores a signal that defines the viewer profiles, the control device also being responsive to insertion order reports that are broadcast to multiple control devices. The control device includes a display portion and a delivery portion that serves the display portion on a point-to-point basis. The broadcast insertion order signals are compared to the viewer profiles. If the display portion of the control device has storage capability, the insertion order is stored in the display portion of the control device. However, if the display device has no storage capacity, the insertion order is stored in the delivery portion of the control device. If the display portion of the control device has no storage capacity, the insertion can still be stored in the delivery portion of the control device.

The broadcast system also sends advertisements to the control device and the control device displays the broadcast advertisements according to the selected insertion orders.

An object of this invention is to improve advertising efficiency by selectively delivering a particular commercial message only to those individual viewers that the advertiser wants to reach with that message.

Another object of this invention is to eliminate inefficiencies associated with previous systems and methods by which targeted commercial delivery systems routed commercials according to multiple or redundant information. Reducing the quantity of information that is transferred thus makes possible the delivery of several billion targeted ads daily.

It is another object of this invention to allow the advertiser or the network broadcaster to convert wasted ad views into saleable ad views.

It is another object of the invention to allow advertisers and their agents who pay for the advertising space to more precisely control the delivery of their messages.

### BRIEF DESCRIPTION OF THE DRAWINGS

The presently disclosed invention is described in connection with the accompanying drawings wherein:

FIG. 1 is a diagram of an ad delivery system and method in accordance with the presently disclosed invention.

FIG. 2 illustrates fields of a typical viewer profile that is stored in a control device in accordance with the presently disclosed invention.

FIG. 3 illustrates the fields of a typical insertion order in accordance with the presently disclosed invention.

### DESCRIPTION OF A PRESENTLY PREFERRED EMBODIMENT

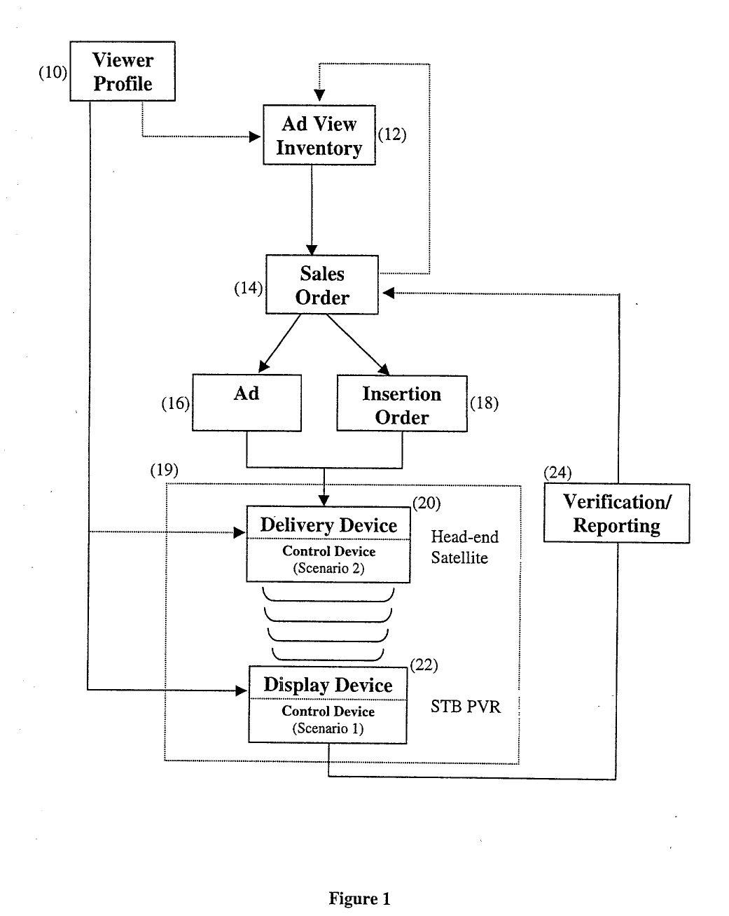

As illustrated in FIG. 1, a system for delivering ads includes a system for developing viewer profiles (10) as is known to those presently skilled in the art. According to known systems and methods, the viewer profiling system (10) characterizes viewers according to various selected criteria such as, for example, audience member affinity groups; viewing patterns; and demographic, psychographic, and geographic factors.

A forecasting system as also known to those skilled in the art develops an inventory database that represents a prediction of the number of viewers who will watch advertisements over a given segment of time (day, week, month, year). The forecasting system periodically updates the inventory database to develop an ad view inventory (12). The ad view inventory (12) is the capacity for delivering addressable ads based on the viewer profiles and the advertisers' target population as defined by viewer characteristics known as ad viewer models. A sales processing system (14) allocates ad views compiled by the forecasting system to specific advertisers according to the advertiser preferences. The advertiser also provides the specific advertisement content that is illustrated in FIG. 1 as Ad (16).

The viewer profiling system (10) distributes profile data to control devices (19) which includes a head-end portion (20), and a display portion (22). The control device (19) authenticates the profile data. Head-end portion (20) is a head-end device for a registered cable TV system or a satellite system. Display portion (22) can be a video display device that contains built-in storage capability. If display portion (22) contains no internal storage capability, the delivery device (20) includes the necessary storage capacity. If the delivery device (20) has the necessary capacity, display devices (22) having storage capability may still be used.

In the presently disclosed system, a profile is developed for each household member. The ad view inventory is the network's capacity to deliver addressable ads that fit an ad view model. The ad view models define viewers in terms of one or more viewer profile parameters. The viewer profile is developed from various information sources and is defined by a number of selected parameters such as geographic, demographic and psychographic attributes of the viewer. Advertisers develop ad view models based on their understanding of their target audience. An ad view inventory for each ad view model is determined by comparing the viewer profiles to the ad view models.

Insertion orders (18) are digital information codes that are derived from sales orders (14). Insertion orders (18) identify the profile of the target viewers, the broadcast source of the advertisements, the channel, date and time when a particular ad is to be broadcast, and any other information as specified according to each sales order.

Insertion orders (18) are broadcast to the display devices (22) through the broadcast delivery device (20). The control device (19) (either at the head-end portion (20) or at the display portion (22)) selects and stores insertion orders based on the profile data that the control device (19) receives from the viewer profiling system (10). Control device 19 selects insertion orders by comparing the portion of the insertion order that defines the viewer profile with the viewer profile information that is stored in control device 19. If the comparison shows that the viewer profile field of the insertion order matches the viewer profile criteria, the insertion order is stored in control device (19). In response to instructions in the advertisement field of the stored insertion order, the control device (19) then records commercials (16) that are broadcast to the broadcast delivery system (20). The commercials are selected for recording based on the commercial field of the insertion order. Also, according to the playback field of the insertion order, the recorded commercials are played back in association with a broadcast message.

The control device (19) also updates the sales processing system (14) through a verification and reporting system (24) that provides delivery confirmation. The ad view inventory (12) is continually updated to reflect existing sales orders (14), changes in the number of viewers and their profiles; and omissions, additions, and changes to the ad view models.

The profile is then delivered to a control device, thus enabling the control device to acquire selected commercials and to display those commercials to a viewer as is further explained herein. The control device is programmed to store the viewer profile and then monitor an assigned broadcast channel for insertion orders. The insertion orders determine which ads will be acquired and presented to the viewer.

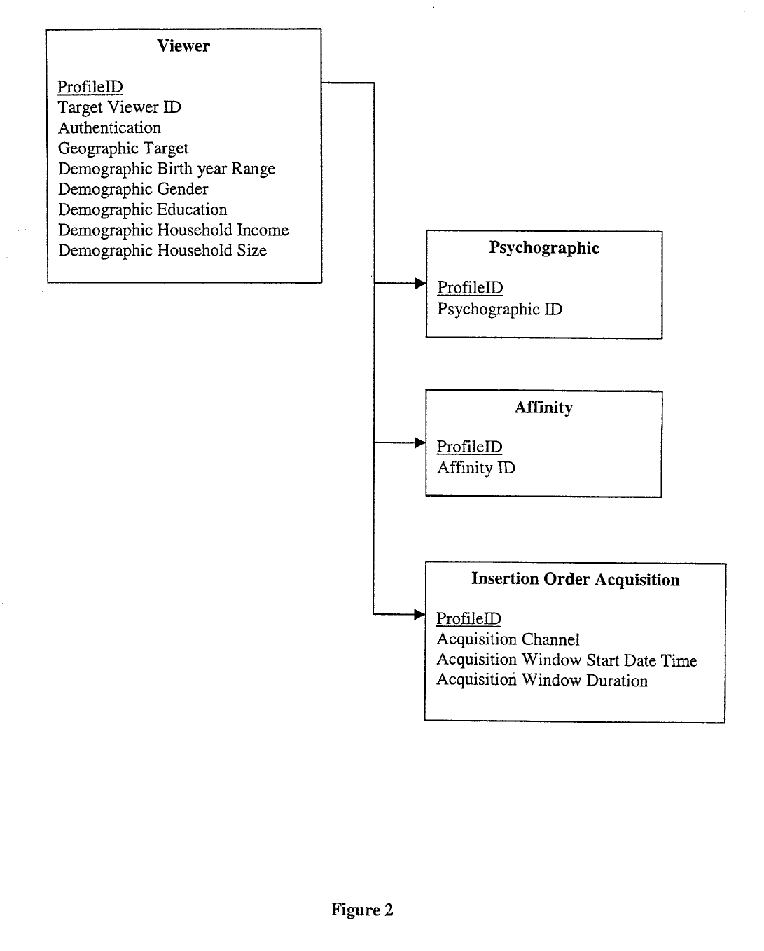

A typical viewer profile is illustrated in FIG. 2. It includes the following data elements:

Profile ID—data element that uniquely identifies a profile for a single viewer.

Targeted Viewer ID—data element that uniquely identifies the viewer being profiled. Optionally corresponds to the PIN a viewer enters on his or her infrared remote control device.

Authentication—data used to authenticate the originator of profiles and insertion orders

Geographic Target—the Zip code, MSA or area code of the targeted viewer or household. The profile may have multiple Geographic Targets, each indicating a specific method (e.g., Zip code, MSA, state, area code) for locating a viewer within a specific geographic boundary.

Demographic Target—the age, household income, gender, educational level of the targeted viewer or household. The profile may specify only one viewer profile.

Psychographic Target—specific psychographic of the targeted viewer or household. The profile may specify multiple psychographic targets for the viewer.

Affinity Group Target—the affinity group memberships of the targeted viewers (e.g., Dog Owner, Frequent Flyer, etc.) or the targeted household. The profile may specify multiple affinity group targets for the viewer.

Insertion order (10) delivery address—specifies the channel number for a local broadcaster or the network call letters (e.g., NBC, ABC, CBS, FOX, HGTV, CNN) of the national broadcaster. There may be multiple insertion order delivery parameters enabling the originator of the profile several opportunities to deliver their insertion order over a broadcast means.

After the viewer profile is stored in the control device, the insertion orders are broadcast on one or more assigned channels.

The insertion order contains fields that define the profile, targeted ad acquisition, and targeted ad delivery for the control device.

The viewer profiles that are stored in the control device include Insertion Order Acquisition fields (FIG. 2). The Insertion Order Acquisition fields identify the channels that the control device is to monitor for insertion orders. To identify insertion orders that are to be selected by the control device, the control device compares various fields of the viewer profile with fields in the insertion order. When the appropriate fields of the viewer profile match the corresponding fields of the insertion order, the control device selects the insertion order. In the example of the preferred embodiment, the fields of the viewer profile that are compared to the fields of the insertion order are as follows:

Insertion Order ID—a unique identifier for each insertion order. This is assigned.by the profile originator.

Authentication—The control device authenticates the broadcaster insertion order and the originator, typically a broadcaster of at least one stored profile.

Geographic Target(s)—the State(s), Zip code(s), MSA(s) or area code(s) of the targeted viewer or household. Null matches all Geographic Targets in the profile.

Demographic Target—the age, household income, gender, educational level of the targeted viewer or household. A viewer has only one Demographic Target. Null matches all Demographic Targets.

Psychographic Target(s)—the psychographic system used (e.g., VALS) and the specific psychographic profile of the targets. Null matches all Psychographic Targets contained in the profile. A viewer may have multiple Psychographic Targets.

Affinity Group Target—the affinity group memberships of the targeted viewers (e.g., Dog Owner, Frequent Flyer, etc.) or the targeted household. A viewer may belong to multiple Affinity Groups.

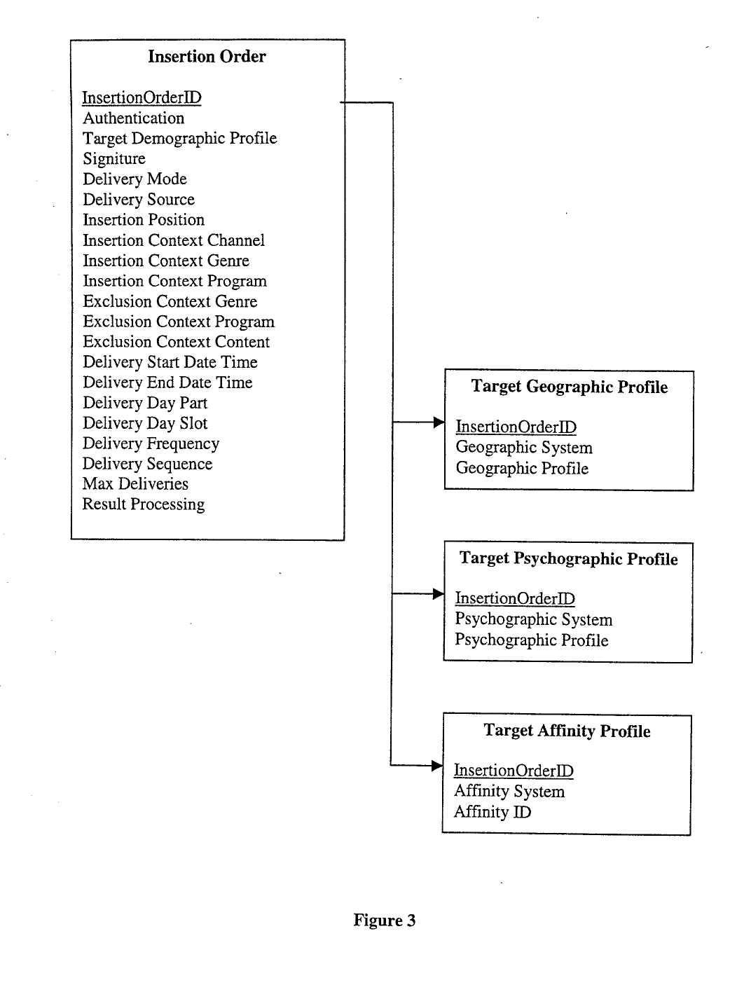

The Advertiser wants to deliver Targeted Ads (TAs) to specific individuals and households. A typical insertion order is illustrated in FIG. 3. It includes the following fields:

The Signature (SIG) is a unique identifier that is associated with a particular broadcaster-originated commercial. For example, the SIG could be the date, time and broadcast originator (network or local). Alternatively, the SIG could be a 32-bit checksum of the digital embodiment (MPEG) or some other unique quality of the commercial (e.g., Date, Time, Channel).

In each case, the data element that is the SIG which identifies the targeted ad is not embedded in the commercial. Instead, the SIG is computed by the sender and the receiver. The SIG is broadcast as part of the insertion order and, if selected according to the viewer profile, the SIG is recorded in the memory of the control device.

The Delivery Mode identifies the network delivery mode for the commercial (e.g., datacast, analog broadcast).

The Delivery Source identifies the source that is compatible with the TA Delivery Mode (i.e., multicast address, channel or network call letters).

The control device can store the insertion order in memory and compare it with the relevant fields of the targeted ads at a later time. If all of the fields match, the control device acquires the targeted ad and delivers the targeted ad for display. This allows the broadcaster to prepare a single commercial ad without regard to a particular target audience.

The Insertion Position is determined by the insertion order. The insertion order has two delivery modes:

Insert a Trailer Commercial in front of or at the end of a recorded video stream. As used herein, “Trailer Commercials” are commercials that are placed at the beginning or at the end of a recorded program and are not associated with particular programming. In this case the Target Ad Insertion Position value is null.

Insert a commercial in place of an originally broadcast commercial that is contained in a regularly scheduled program that was recorded. The control device follows the insertion order and substitutes for the broadcast commercial a pre-recorded commercial that is specified in the insertion order.

Insertion Context Channel—If null, the control device may insert the ad into, before, or after, programming originally broadcast on any channel. Otherwise, the control device must insert the TA into broadcast content that originated on specific local channels or networks contained in this field. The TA insertion position options #1 and #2 have precedence over this field. Typically, the Insertion Context Channel is used to insert ad trailers in front of or at the end of a recorded program.

Insertion Context Genre—If null, the control device may insert the TA into, before, or after any genre. Otherwise, the control device must insert the TA in front of or after recorded programming identified in this field.

Insertion Context Title—If null, the control device may insert the TA into, before, or after any program. Otherwise, the control device must insert the TA into, in front of or after recorded programming identified in this field.

Exclusion Context Genre—If null, the control device may insert the TA into, before, or after any type of programming. Otherwise, the control device will not insert the ad in the specified genres. This parameter overrides “TA Insertion” parameters.

Exclusion Context Program—If null, the control device may insert the TA into, before, or after any program title. Otherwise, the control device must prevent insertion into any program titles described in this field. This parameter overrides “Insertion” parameters.

Exclusion Context Content—If null, the control device may insert the TA into, before, or after any program regardless of content. Otherwise, if content is detected by the control device the TA will not be inserted. For example, a pizza delivery commercial would not be displayed if the closed caption indicated the programming contained dangerous driving sequences. This parameter overrides “Insertion” parameters.

Delivery Start Date and Time—This rule specifies the earliest date and time the control device may insert the TA into, before, or after a recorded program.

A Delivery End Date and Time specifies the date after which the control device must stop inserting the TA into, before, or after a recorded program.

A Delivery Day Part(s) rule specifies in which local three-hour segments the control device may insert the TA into a recorded program. The advertisers can specify multiple day parts.

A Delivery Day Slot specifies which days of the week (Sunday through Saturday) that the control device may insert the TA into a recorded program. The advertiser can specify multiple day slots.

Frequency rule—The control device must wait this many minutes before inserting the TA a second or subsequent time into, before, or after a recorded program.

Sequence rule—The TA must display this many ads (targeted or broadcast) before the next insertion of the TA. For example, at least two other ads must be displayed before this ad is displayed a second, third, or fourth time into, before, or after a recorded program.

Max ad view rule—the maximum number of times this ad can be inserted into, before, or after a program between the Deliver Start and Delivery end dates.

Results Processing—Specifies how the control device will store and forward Targeted Ad Delivery Results. Minimally, the control device stores the Insertion Order ID and the date and time of delivery. The Result Data is compressed, encrypted, transmitted to the authenticated profiler and deleted from the control device.

### FIRST EXAMPLE

### Insert a Trailer Targeted Ad into the Playback of a Recorded Program with Local Storage

In this example, the control device is a digital set-top box that has a local disk drive capable of storing several video advertisements [(22) in FIG. 1, scenario 1]. The set-top box has a unique address and is installed in the viewer's home.

The control device (19) inserts a trailer-targeted ad into a recorded program. The control device (19) receives a profile that is transmitted by a network broadcaster through an Internet or network connection to the specific set-top box. The profile contains the data specified in FIG. 2.

Next, the network broadcasts several insertion orders (see FIG. 3) on a specific channel and at a specific date and time. The control device (19) selects those insertion orders for which the insertion order profile parameters match the stored profile and stores the selected insertion orders in memory.

Thereafter, the control device (19) acquires the targeted ad based on the SIG, delivery mode and delivery source, and then records the targeted ad on its disk drive. The control device (19) inserts the targeted ad at the beginning or end of a playback-recorded program in accordance with the delivery parameters in the insertion order.

### SECOND EXAMPLE

### Insert/Replace a Targeted Ad into the Playback of a Recorded Program with Local Storage

In a second example, the control device is a digital set-top box that has a local disk drive capable of storing several video advertisements [(22) in FIG. 1, scenario 1]. The set-top box has a unique address and is installed in the viewer's home. To insert a targeted ad into a recorded program, the control device (19) receives a profile that is transmitted by a network broadcaster through an Internet or network connection to the specific set-top box. The profile contains the data specified in FIG. 2.

Next, the network broadcasts several insertion orders (see FIG. 3) on a specific channel and at a specific date and time. The control device (19) selects those insertion orders for which the insertion order profile parameters match the stored profile and stores the selected insertion orders in memory.

Thereafter, the control device (19) acquires the targeted ad based on-the SIG, delivery mode and delivery source, and then stores the targeted ad on its disk drive. The control device (19) inserts/replaces the targeted ad into a playback-recorded program in accordance with the delivery parameters in the insertion order.

### THIRD EXAMPLE

### Insert/Replace a Targeted Ad into a Live Broadcasted Program, with Local Storage

In a third example, a digital set-top box has a local disk drive that is capable of storing several video advertisements. It also has a unique address and is installed in the viewer's home. The display device [(22) in FIG. 1, scenario 1] is also the control device.

The control device (19) inserts a targeted ad into a live broadcast. First, the control device (19) receives a profile that is transmitted by a network broadcaster through an Internet or network connection to the set-top box. The profile contains the data specified in FIG. 2.

Next, the network broadcasts several insertion orders (see FIG. 3) on a specific channel and at a specific date and time. The control device (19) selects those insertion orders that have insertion order profile parameters that match the profile that is stored. The control device (19) stores each of the selected insertion orders in memory.

Thereafter, the control device (19) acquires the targeted ad based on the SIG, delivery mode and delivery source. The control device (19) records the acquired targeted ad on its local disk drive. Finally, the control device (19) inserts/replaces the targeted ad into a broadcast according to the delivery parameters in the insertion order.

### FOURTH EXAMPLE

### Insert a Trailer Targeted Ad into the Playback of a Recorded Program, Without Relying on Local Storage

In a fourth example, the control device is the head-end that has a centralized storage device capable of storing multiple video advertisements [(20) in FIG. 1, scenario 2]. The set-top box (22) is served by the delivery system in a point-to-point basis. The set-top box (22) may or may not have local storage capability.

The control device (20) inserts a trailer-targeted ad into a recorded program. The control device (20) receives a profile that is transmitted by a network broadcaster through an Internet or network connection. The profile contains the data specified in FIG. 2.

Next, the network broadcasts several insertion orders (see FIG. 3). The control device (20) selects those insertion orders for which the insertion order profile parameters match the stored profile and stores the selected insertion orders in memory.

Thereafter, the control device (20) acquires the targeted ads, and stores them on the centralized storage device. The control device (20) inserts the targeted ads at the beginning or end of a playback-recorded program in accordance with the delivery parameters in the insertion order, when the set-top box is served by the specialized head-end service.

### FIFTH EXAMPLE

### Insert/Replace a Targeted Ad into the Playback of a Recorded Program, Without Relying on Local Storage

In a fifth example, the control device is the head-end that has a centralized storage device capable of storing multiple video advertisements [(20) in FIG. 1, scenario 2]. The set-top box (22) is served by the delivery system in a point-to-point basis. The set-top box (22) may or may not have local storage capability.

The control device (20) inserts a trailer-targeted ad into a recorded program. The control device (20) receives a profile that is transmitted by a network broadcaster through an Internet or network connection. The profile contains the data specified in FIG. 2.

Next, the network broadcasts several insertion orders (see FIG. 3). The control device (20) selects those insertion orders for which the insertion order profile parameters match the stored profile and stores the selected insertion orders in memory.

Thereafter, the control device (20) acquires the targeted ads, and stores them on the centralized storage device. The control device (20) inserts/replaces the targeted ads into a playback-recorded program in accordance with the delivery parameters in the insertion order, when the set-top box is served by this specialized head-end service.

Still other preferred embodiments and other examples of the subject invention will be apparent to those skilled in the relevant art and are included within the scope of the following claims.

What is claimed is:

1. Apparatus for delivering selected commercials in correspondence with viewer profiles, said apparatus being responsive to a viewer profile signal wherein the viewer profile signal includes selected viewer criteria, said apparatus also being selectively responsive to an insertion order signal wherein the insertion order signal includes a viewer profile field and a commercial acquisition field, said apparatus comprising:
a memory for storing portions of the viewer profile signal;
means for comparing the viewer criteria of the viewer profile signal with the viewer profile field of the insertion order signal and storing the insertion order signal in memory when at least a portion of the viewer profile field matches at least a portion of the viewer criteria of the viewer profile signal; and
means for acquiring a commercial signal in accordance with the commercial acquisition field of acquired insertion order signals.

2. Apparatus for delivering selected broadcast commercials in correspondence with viewer profiles, said apparatus comprising:
a control device that is responsive to a viewer profile signal, said control device storing signal data that defines viewer criteria, said control device also responsive to the viewer profile signal to monitor at least one selected signal channel for insertion order signals;
a first means for acquiring insertion order signals in said control device, said insertion order signals defining selected viewer criteria and also defining acquisition criteria, said acquisition criteria also defining display criteria that establish the conditions for display of the recorded commercial message, said first acquiring means comparing the viewer criteria of the viewer profile signal with the viewer criteria of the insertion order and selecting insertion orders that are communicated to said control device in accordance with fields of the viewer profile; and
a second means for acquiring commercial signals, said second acquiring means selecting broadcast commercial signals according to the acquisition criteria of the insertion order, the acquisition criteria of said insertion order signals being independent of any portion of the broadcast commercial.

3. In a system for broadcasting advertisements in connection with broadcast programming, apparatus for displaying selected advertisements in correspondence with a viewer profile, said apparatus comprising:
a control device for use in displaying broadcast programming, said control device being responsive to a network signal to store said network signal wherein at least a portion of said network signal defines a viewer profile;
means for broadcasting insertion orders and commercial messages to said control device, said control device acquiring insertion orders that are broadcast to said control device by matching a field of the insertion order with at least a portion of the viewer profile; and
means for displaying commercial messages in accordance with the data in a selected field of the insertion order.

4. In a system for broadcasting advertisements in connection with broadcast programming, apparatus for displaying selected advertisements in correspondence with a viewer profile, said apparatus comprising:
a control device for use in displaying broadcast programming, said control device being responsive to a viewer profile signal wherein at least a portion of said viewer profile signal defines a viewer profile;
means for broadcasting insertion orders to said control device, said insertion orders including a signature field that is associated with a given advertisement, said control device monitoring selected channels acquiring insertion orders in accordance with fields of the viewer profile, and recording the selected insertion orders, including the advertisement signature; and
means for broadcasting advertisements to said control device, said control device displaying ads that are identified according to the signature field of the insertion order, said signature field including selection criteria for determining the play time of the advertisement where said selection criteria is independent of any portion of the broadcast advertisement.

5. The system of claim 4 wherein the control device comprises a personal video recorders.

6. The system of claim 4 wherein the control device comprises satellite recorders.

7. The system of claim 4 wherein the control device comprises cable head-end recorders.

8. The system of claim 4 wherein the control device authenticates the profile data and the insertion order.

9. The system of claim 4 wherein said control device records the commercial identified in the insertion order in response to instructions in the insertion order.

10. The system of claim 4 wherein said control device transmits information to the sales processing system that the commercials have been played.

11. The system of claim 4 wherein the profile information uniquely identifies the viewer who is being profiled.

12. The system of claim 4 wherein the profile information includes information that authenticates the origin of the profiles and the insertion orders.

13. The system of claim 4 wherein the profile information includes information that identifies the geographic location of the viewer.

14. The system of claim 4 wherein the profile information includes information that identifies demographic information about the viewer.

15. The system of claim 4 wherein the profile information includes information of an affinity group for the targeted viewer.

16. The system of claim 4 wherein the profile information includes an address by which that broadcaster will deliver the insertion order.

17. The system of claim 4 wherein insertion orders are broadcast over at least one channel.

18. The system of claim 17 wherein the insertion order contains a targeted ad signature that identifies the network delivery mode for the commercial.

19. The system of claim 17 wherein the insertion order contains a targeted ad signature that identifies the source that is compatible with the network delivery mode.

20. The system of claim 4 wherein the insertion order includes:
profile processing wherein the control device monitors the channels that are identified in the profiles that are stored in the control device;
acquiring the targeted ad in accordance with signature information that identifies the targeted ad and that is broadcast as part of the insertion order and recorded in the control devices memory; and
processing the targeted ad according to a selected delivery mode.

21. The system of claim 20 wherein the signature information identifies the network delivery mode.

22. The system of claim 21 wherein the signature information identifies the source that is compatible with the network delivery mode.

23. A method for delivering selected commercials in correspondence with viewer profiles, a said method comprising the steps of:
transmitting a viewer profile signal to a display device, said viewer profile signal defining selected viewer criteria;
storing the selected viewer criteria in the display device;
broadcasting insertion order signals to a multiple of display devices, said insertion order signals having a viewer profile field and also having a commercial acquisition field;
storing insertion order signals when at least a portion of the viewer profile field matches at least a selected portion of the viewer profile signal;
acquiring commercial signals in accordance with the commercial acquisition field of the insertion order signal.

24. The method of claim 23 wherein the insertion order signal further includes a commercial display field and further comprising the steps of:
displaying acquired commercial signals in accordance with the commercial display field of the insertion order signal.
